(19) United States
(12) Patent Application Publication
(10) Pub. No.: US 2011/0051355 A1
(43) Pub. Date: Mar. 3, 2011

(54) COMPUTER ENCLOSURES SUPPORTING HOT-PLUGGING HARD DISK DRIVE

(76) Inventor: YEN-TE HSIAO, Taipei Hsien (TW)

(21) Appl. No.: 12/552,299

(22) Filed: Sep. 2, 2009

(51) Int. Cl. G06F 1/16

(52) U.S. Cl. 361/679.37

(57) ABSTRACT

A computer enclosure capable of supporting hot plugging of hard disk drives contains an opening on the front plate, the top plate, or a side plate. Through the opening, a disk cabinet is installed. The disk cabinet has a number of hot-plugging connectors for connection to a number of hard disk drives installed in the disk cabinet. Each hot-plugging connector is also connected to a power cable and a data cable to a motherboard in the enclosure. The hard disk drives therefore can be installed or removed from the disk cabinet without shutting down the computer's power and without being configured in a hot-pluggable tray in advance.

### TECHNICAL FIELD OF THE INVENTION

The present invention generally relates to a computer enclosure supporting hot-plugging hard disk drives, and more particularly to such a computer enclosure where a disk cabinet supporting hot plugging of hard disk drives is integrated with the computer enclosure

### DESCRIPTION OF THE PRIOR ART

Hard disk drive is a common data storage component in modern-day computers. Conventionally, a hard disk drive is fixedly installed in a computer's enclosure and, to replace an existing hard disk drive with another one, the computer has to be powered down (the so-called “cold plugging”). To achieve “hot plugging” where the hard disk drive is installed or removed while the computer's power remains on, some auxiliary device is required. For example, the hard disk drive usually has to be installed in a movable tray in advance, which is quite inconvenient.

### SUMMARY OF THE INVENTION

Therefore, a novel computer enclosure supporting hot-plugging hard disk drives is provided. The computer enclosure has an opening on a front, top, or side plate and a disk cabinet is integrated with the computer enclosure through the opening. The disk cabinet is configured with hot-plugging connectors, each of which is connected to a power cable and a data cable to a motherboard in the enclosure. As such, a bare hard disk drive is hot-pluggable without configuring the bare hard disk drive in a hot-pluggable tray or other device in advance.

To install a new or additional hard disk drive, it is directly dropped into the disk cabinet of the computer enclosure and the hard disk drive is directly connected to a hot-plugging connector. To remove a hard disk drive, it could be directly pulled and then moved out of the disk cabinet

Additionally, the disk cabinet could be configured so that it is able to hold one or more hard disk drives of the same or different form factors. The number of hot-plugging connectors is the same as the number of hard disk drives accommodated.

The disk cabinet could further contain a number of door plates configured in parallel along a top side of the disk cabinet. Each door plate has an edge hinged to the disk cabinet and is therefore able to be flipped open for receiving a hard disk drive. Each hinge has a restoration spring. When the restoration spring is at its normal, closure state, a portion of the top side of the disk cabinet is covered. When a hard disk drive is dropped through a door plate, the door plate is pushed to pivot counterclockwise 90 degrees around its hinged edge and the rotation spring is compressed. When the hard disk drive is pulled out of the disk cabinet, the door plate under the driving of the expanding restoration spring is restored to its normal, closure state.

As the door plates are pushed downward by the hard disk drives, the door plates' width should correspond to the depth of the disk cabinet. The number of the door plates is the same as the number of accommodated hard disk drives. In addition, the door plates are configured so as to correspond to the hot-plugging connectors, respectively.

The disk cabinet is able to hold a specific number of 3.5″ hard disk drives. On the other hand, each door plate could have an opening whose position corresponds to a hot-plugging connector. To install a 3.5″ hard disk drive, the hard disk drive would push the door plate to pivot around the hinged edge. On the other hand, to install a 2.5″ hard disk, it could be directly dropped into the opening of a door plate.

The disk cabinet is fully integrated to the computer enclosure and the hard disk drives could be installed or removed barely without shutting down the computer's power. The hard disk drive is not required to be configured in a hot-pluggable tray in advance and therefore it is very convenient. In the mean time, the door plates of the disk cabinet prevent dust or debris to contaminate the hot-plugging connectors.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing the various components of a computer enclosure according to an embodiment of the present invention.

FIG. 2 is a perspective diagram showing the enclosure of FIG. 1 after a number of hard disk drives are installed.

FIG. 3 is a perspective diagram showing the disk cabinet of the enclosure of FIG. 1 when it is fully configured with hard disk drives.

FIG. 4 is a perspective diagram showing the disk cabinet of the enclosure of FIG. 1 when there is no hard disk drive installed.

FIG. 5 is a perspective diagram showing the various components of a computer enclosure according to another embodiment of the present invention.

FIG. 6 is a perspective diagram showing the enclosure of FIG. 5 after a hard disk drive is installed.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

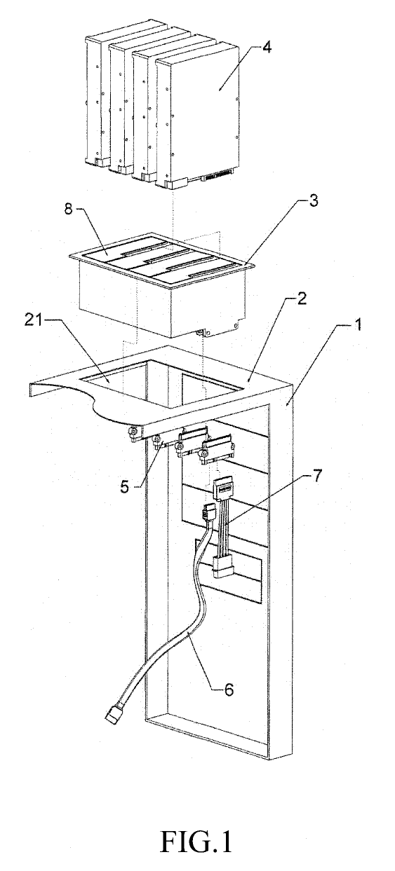

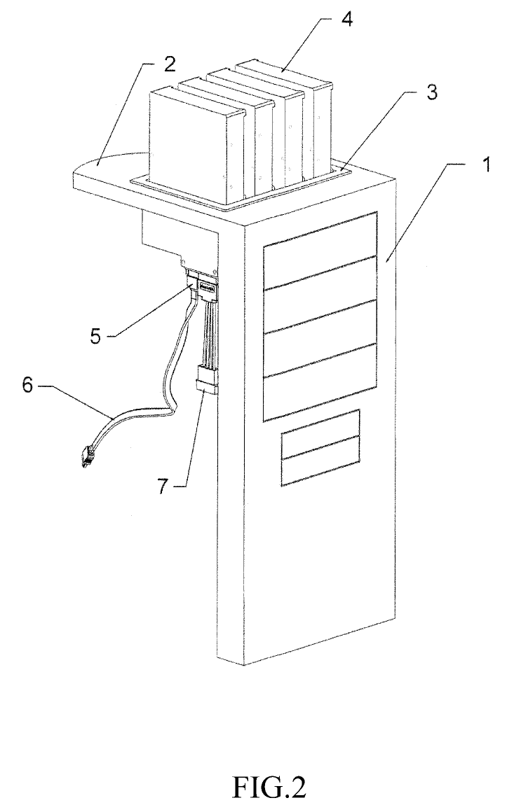

As shown in FIGS. 1 and 2, a computer enclosure according to an embodiment of the present invention mainly contains a front face plate 1, a top plate 2, a bottom plate, two side plates, and a back plate, jointly forming the enclosure. The top plate 2 has an opening 21 through which a disk cabinet 3 is placed. The disk cabinet 3 has an opening through which a specific number of hard disk drives is accommodated. For example, in the present embodiment, the disk cabinet 3 is able to hold four 3.5″ hard disk drives 4. The disk cabinet 3 further contains a number of connectors 5 supporting hot plugging underneath the disk cabinet 3. The connectors 5 are arranged so that each corresponds to a hard disk drive 4 installed in the disk cabinet 3 and, when a hard disk drive 4 is dropped into the disk cabinet 3, a connector of the hard disk drive 4 is automatically joined to a connector 5. Each connector 5 is connected to a power cable 7 and a data cable (such as a SATA cable) 6 for connection to a motherboard in the enclosure. When the hard disk drive 4 has to be removed, it could be directly pulled out of the disk cabinet 3 without shutting down the power and the hard disk drive 4 is detached from the connector 5 automatically. For a person skilled in the related art, it could be easily imagined that the above configuration could be applied to hard disk drives of various form factors.

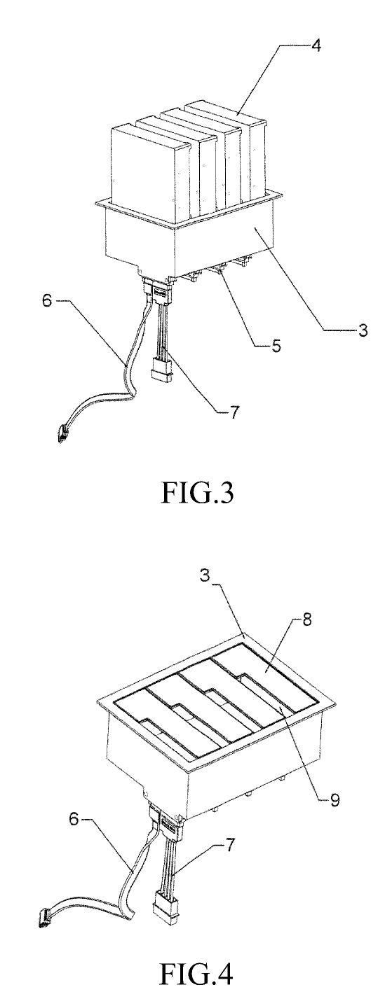

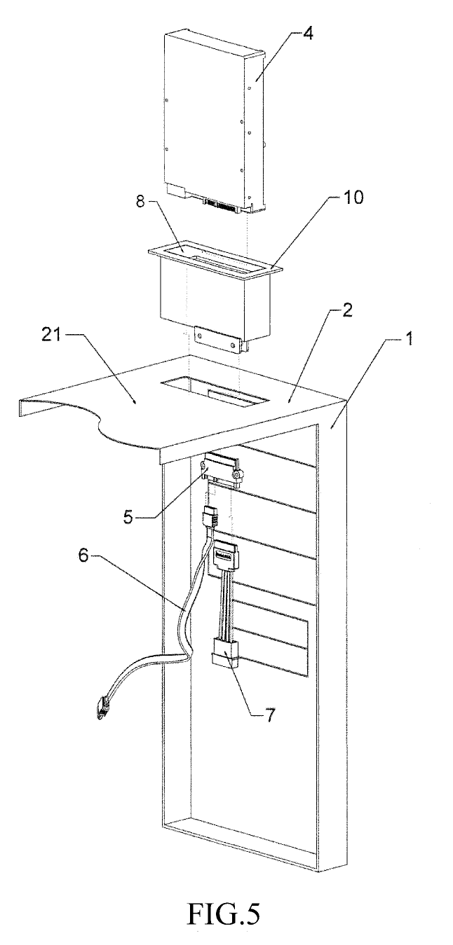

As shown in FIGS. 3 and 4, a top side of the disk cabinet 3 is configured with four door plates 8 in parallel, each of which has an edge hinged to the disk cabinet 3 and is therefore able to be flipped open for receiving a hard disk drive 4. Each hinge (not shown) has a restoration spring (also not shown) so that, when the hard disk drive 4 is pulled out, the door plate 8 is restored to a closure state to block a portion of the top side of the disk cabinet 3. Each door plate 8 has an opening 9 conforming to the dimension of a 2.5″ hard disk drive along an edge opposing to the hinged edge of the door plate 8. Each door plate 8 is configured so that it corresponds to a connector 5. When the restoration spring is at its normal, closure state, a portion of the top side of the disk cabinet 3 is covered. When a 3.5″ hard disk drive 4 is dropped through a door plate 8, the door plate 8 is pushed to pivot counterclockwise 90 degrees around its hinged edge and the rotation spring is compressed. When the hard disk drive 4 is pulled out of the disk cabinet 3, the door plate 8 under the driving of the expanding restoration spring is restored to its normal, closure state. For a 2.5″ hard disk drive, it could be directly dropped through the opening 9 of a door plate 8 for installation into the disk cabinet 3.

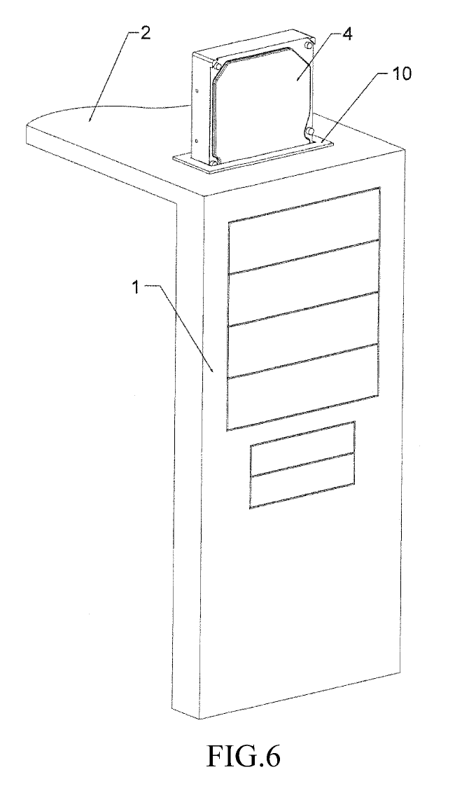

As shown in FIGS. 5 and 6, a computer enclosure according to another embodiment of the present invention has a disk cabinet 10 capable of holding a single hard disk drive 4 and the disk cabinet 10 has a connector 5 on a bottom side of the disk cabinet 10. The connector 5 is connected to a power cable 7 and a data cable 6 which in turn is connected to a motherboard in the enclosure.

The disk cabinet 3 or 10 is fully integrated with a computer enclosure and the hard disk drives 4 could be installed or removed barely without shutting down the computer's power. The hard disk drive 4 is not required to be configured in a hot-pluggable tray in advance and therefore it is very convenient. In the mean time, the door plates 8 of the disk cabinet 3 or 10 prevents dust or debris from contaminating the connectors 5.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A computer enclosure supporting hot-plugging hard disk drive, comprising:
an opening on one of a front plate, a top plate, and a side plate of said computer enclosure; and
a disk cabinet fixedly installed in said opening, said disk cabinet having an opening exposed from said opening of said computer enclosure, said disk cabinet having at least a hot-plugging connector connected to a power cable and a data cable which is in turn connected to a motherboard in said computer enclosure.

2. The computer enclosure according to claim 1, wherein said disk cabinet is capable of accommodating at least a hard disk drive of a specific dimension; and the number of hard disk drives accommodated is the same as the number of said hot-plugging connectors.

3. The computer enclosure according to claim 2, wherein said opening of said disk cabinet is covered by at least a door plate; an edge of said door plate is hinged to said disk cabinet so that said door plate is able to pivot around said hinged edge; a restoration spring is configured along said hinged edge; and, under said restoration spring's normal state, said door plate covers at least a portion of said opening of said disk cabinet.

4. The computer enclosure according to claim 3, wherein, when a hard disk drive is dropped and installed in said disk cabinet, said door plate pivots said hinged counterclockwise for 90 degree and said restoration spring is compressed; and, when said hard disk drive is pulled out of said disk cabinet, said restoration spring expands to restore said door plate back to the door plate's normal state.

5. The computer enclosure according to claim 4, wherein said disk cabinet is capable of accommodating at least a 3.5″ hard disk drive; said door plate has an opening along an edge opposing to said hinged edge; said opening of said door plate corresponds to the dimension of a 2.5″ hard disk drive; and said opening of said door plate corresponds to a hot-plugging connector.
